(19) United States
(12) Patent Application Publication
(10) Pub. No.: US 2012/0208174 A1
(43) Pub. Date: Aug. 16, 2012

(54) Plasmonic System for Detecting Binding of Biological Molecules

(75) Inventors: William J. Galush, Redwood City, CA (US); Sarah A. Shelby, Ithaca, NY (US); Martin J. Mulvihill, Oakland, CA (US); Andrea R. Tao, La Jolla, CA (US); Peidong Yang, Kensington, CA (US); John T. Groves, Berkeley, CA (US)

(73) Assignee: THE REGENTS OF THE UNIVERSITY OF CALIFORNIA, Oakland, CA (US)

(21) Appl. No.: 13/204,506

(22) Filed: Aug. 5, 2011

Related U.S. Application Data
(63) Continuation of application No. PCT/US2010/023375, filed on Feb. 5, 2010.
(60) Provisional application No. 61/150,680, filed on Feb. 6, 2009.
(60) Provisional application No. 61/174,855, filed on May 1, 2009.

(51) Int. Cl. G01N 21/75; G01N 21/47; G01N 21/59; G01N 21/55; B82Y 15/00

(52) U.S. Cl. 435/5; 436/501; 435/7.1; 977/773; 977/810; 977/902

(57) ABSTRACT

Detection and characterization of molecular interactions on membrane surfaces is important to biological and pharmacological research. In one embodiment, silver nanocubes interfaced with glass-supported model membranes form a label-free sensor that measures protein binding to the membrane. The present device and technique utilizes plasmon resonance scattering of nanoparticles, which are chemically coupled to the membrane. In contrast to other plasmonic sensing techniques, this method features simple, solution-based device fabrication and readout. Static and dynamic protein/membrane binding are monitored and quantified.

### CROSS-REFERENCE TO RELATED APPLICATIONS

This application claims priority to PCT International Application No. PCT/US2010/023375, filed on Feb. 5, 2010, hereby incorporated by reference in its entirety, which claims priority to U.S. Provisional Patent Application, 61/150,680, filed on Feb. 6, 2009, and U.S. Provisional Patent Application, 61/174,855, filed on May 1, 2009, each of which is incorporated by reference in its entirety.

### STATEMENT OF GOVERNMENTAL SUPPORT

This invention was made with government support under Contract No. DE-AC02-05CH11231 awarded by the U.S. Department of Energy. The government has certain rights in the invention.

### REFERENCE TO SEQUENCE LISTING, TABLE, OR COMPUTER PROGRAM APPENDIX

Not applicable.

### BACKGROUND OF THE INVENTION

1. Field of the Invention

The present invention relates to the fields of surface plasmonic sensing compositions, methods and devices for the detection of molecular binding on membrane surfaces.

2. Related Art

Metal nanostructures can be used for the label-free optical detection of molecular binding to surfaces. This is due to strong, environmentally-sensitive light scattering caused by the localized surface plasmon resonance (LSPR) of electrons at the metal surface. (Kelly, K.; Coronado, E.; Zhao, L.; Schatz, G. Journal of Physical Chemistry B 2003, 107, 668-677). Characteristic LSPR spectra exist for a variety of shapes and configurations of particles, (See Baciu, C. L.; Becker, J.; Janshoff, A.; Sonnichsen, C. Nano Letters 2008, 8, 1724-1728; Yonzon, C. R.; Jeoungf, E.; Zou, S. L.; Schatz, G. C.; Mrksich, M.; Van Duyne, R. P. Journal of the American Chemical Society 2004, 126, 12669-12676; Prikulis, J.; Hanarp, P.; Olofsson, L.; Sutherland, D.; Kall, M. Nano Letters 2004, 4, 1003-1007; Tao, A.; Sinsermsuksakul, P.; Yang, P. D. Angewandte Chemie-International Edition 2006, 45, 4597-4601; and Tao, A.; Sinsermsuksakul, P.; Yang, P. Nature Nanotechnology 2007, 2, 435-440) and similar to conventional surface plasmon resonance (SPR) spectrometry, the scattering spectra of the nanostructures are dependent upon the refractive index of the surrounding medium, which enables the detection of molecular binding to or near the nanostructure surface.(Zhao, J.; Das, A.; Zhang, X.; Schatz, G.; Sligar, S.; VanDuyne, R. Journal of the American Chemical Society 2006, 128, 11004-11005, Haes, A.; Chang, L.; Klein, W.; VanDuyne, R. Journal of the American Chemical Society 2005, 127, 2264-2271).

There is a pronounced need for analytical technology capable of probing molecular interactions in a cell membrane environment. Most biochemical processes involve membranes at some point and, correspondingly, over half of the one hundred best selling marketed drugs target cellular membrane-associated proteins[Drews, J. Science 2000, 287, 1960-1964, Yildirim, M. A.; Goh, K.-I.; Cusick, M. E.; Barabasi, A.-L.; Vidal, M. Nat Biotech 2007, 25, 1119-1126]. To address this need, there has been significant interest in supported lipid bilayers[Sackmann, E. Science 1996, 271, 43-48, Groves, J. T. Current Opinion in Drug Discovery and Development 2002, 5, 606-612, and Tanaka, M.; Sackmann, E. Nature 2005, 437, 656-663], which share many of the same properties as cellular membranes. In particular, supported membranes retain lateral fluidity, and allow membrane components to rearrange naturally in response to molecular interactions. Furthermore, membrane proteins are notoriously difficult to work with outside of the membrane environment; supported membranes offer a strategy to handle these. G-protein coupled receptors provide a case in point, and have been screened in a supported membrane microarray format[Bieri, C.; Ernst, O. P.; Heyse, S.; Hofmann, K. P.; Vogel, H. Nat Biotech 1999, /7, 1105-1108, Fang, Y.; Frutos, A. G.; Lahiri, J. ChemBioChem 2002, 3, 987-991]. Supported membranes have also been used to reconstitute protein-protein signaling at membrane surfaces[Gureasko, J.; Galush, W. J.; Boykevisch, S.; Sondermann, H.; Bar-Sagi, D.; Groves, J. T.; Kuriyan, J. Nat Struct Mol Biol 2008, 15, 452-461] and to imitate one face of cell-cell junctions at T-cell synapses[Groves, J. T.; Dustin, M. L. Journal of Immunological Methods 2003, 278, 19-32, Mossman, K. D.; Campi, G.; Groves, J. T.; Dustin, M. L. Science 2005, 310, 1191-1193].

Many drug targets are membrane-resident, so detecting binding at membranes is important for drug discovery, as well as biological research more generally. There are no commercial platforms that provide a way to screen these kinds of interactions in a phospholipid membrane environment.

The most common, comparable, way of probing molecular interactions for drug discovery in vitro is surface plasmon resonance (SPR), which involves very expensive instrumentation and consumables. Surface plasmon resonance is also not compatible with phospholipid membranes. There is a relative lack of techniques for measuring interfacial binding at membrane surfaces, and especially a lack of techniques which are label-free. The most common surface binding tools, such as surface plasmon resonance (SPR), are generally not compatible with membranes. In fact, there is no commercially standard technique for measuring binding at bilayer membrane surfaces. While there are academic studies that use surface-based noble metal nanostructures as membrane binding sensors, many require burdensome technical requirements such as micropatterning of substrates.

Thus there is a need for parallel high-throughput applications for the detection of binding at membrane surfaces which require only simple readout as distinguished from conventional SPR and related nanomaterial-based sensors.

### BRIEF SUMMARY OF THE INVENTION

The present invention provides a sensor for detecting the binding of molecules to membrane surfaces. In one embodiment, the sensor comprising nanoscale silver cubes deposited on a glass surface and which are embedded in a phospholipid membrane that coats the entire surface of the device.

In another aspect, the present invention provides a composition comprising, a substrate having a continuous membrane coating, wherein the substrate features nanoparticles disposed between the membrane coating and the substrate. In some embodiments, the substrate is planar, spherical or a wall of a microfluidic channel. The membrane coating over the substrate is a supported lipid bilayer and the membrane coating over the nanoparticles is a hybrid lipid bilayer. The nanoparticles comprises nanopolyhedras. In one embodiment, the nanopolyhedra is a nanocube. The nanoparticles can comprise a metal, a semiconductor material, multi-layers of metals, a metal oxide, an alloy, a polymer, or carbon nanomaterials. In one embodiment, the nanoparticles comprise metal such as gold or silver.

In a further aspect, to form the hybrid lipid bilayer, the nanoparticles are chemically modified to display a self-assembled monolayer. In one embodiment, the membrane coating further comprising a ligand within the membrane. In another embodiment, the sensor further comprising an analyte molecule possibly capable of binding the ligand, wherein the analyte is a cell-surface protein or a functionalized lipid headgroup.

One object of the invention is to provide a nano-plasmonic sensing device having simplicity of fabrication and of readout. In one embodiment, the manufacture of the basic sensor surface is based on a series of solution-based deposition and wash steps, and the readout is using simple absorbance spectrophotometry in an off-the-shelf instrument. The device presented herein is potentially easily parallelized for high-throughput applications, which distinguishes it from conventional SPR and related nanomaterial-based sensors.

Thus the invention also provides a method comprising: (a) contacting a target molecule with a substrate having a continuous membrane coating a plurality of nanoparticles disposed between the membrane and the substrate, (b) applying a molecule possibly capable of binding the target molecule, and (c) detecting plasmon generated phenomena at a nanoparticle.

In one embodiment, the plasmon-generated phenomena is optically detectable. In another embodiment, the step of detecting plasmon-generated phenomena comprises detecting light selected from absorbed light, reflected light, scattered light, or any combination thereof, and further wherein the method of detection comprises any combination selected from imaging, spectral characterization, intensity measurement, interferometry, and interference fringe analysis.

In another embodiment, the method further comprising: detecting a spectral shift in the known spectra of the nanoparticles, wherein such a spectral shift indicates the presence of the molecule possibly capable of binding the target molecule.

In one embodiment, the target molecule is a cell-membrane protein or a functionalized lipid headgroup.

In one embodiment, a sensor comprising a substrate having nanoparticles embedded on said substrate and a continuous supported lipid membrane coating said substrate and nanoparticles, wherein the nanoparticles are chemically modified to display a self-assembled monolayer such that subsequent exposure of the surface to lipid vesicles results in formation of a continuous lipid membrane coating the nanoparticles and the supporting substrate.

In another embodiment, a method for detecting an analyte of interest comprising the steps of: (a) providing a substrate having a continuous membrane coating, wherein the substrate features nanoparticles disposed between the membrane coating and the substrate, wherein the nanoparticles have a known spectra, and wherein the continuous membrane displays a ligand for the analyte of interest; (b) applying a sample suspected of containing a target analyte of interest to the substrate; (c) detecting plasmon generated phenomena at the nanoparticles, whereby a spectral shift in the known spectra of the nanoparticles indicates that the target analyte is bound to the ligand.

The ligand within the membrane can be oligonucleotides, ribonucleic acid residues, deoxyribonucleic acid residues, polypeptides, proteins, receptors, carbohydrates, a lipid-linked small molecule, thyroxine binding globulin, antibodies, enzymes, Fab fragments, lectins, nucleic acids, nucleic acid aptamers, avidin, protein A, barsar, complement component C1q, or other organic or inorganic molecules having a binding affinity for an analyte of interest.

Analytes of interest that can be detected include nucleic acid molecules, proteins, peptides, haptens, metal ions, drugs, metabolites, pesticides, pollutants, toxins, hormones, enzymes, lectins, proteins, signaling molecules, inorganic or organic molecules, antibodies, contaminants, viruses, bacteria, other pathogenic organisms, idiotopes and cell surface markers.

### BRIEF DESCRIPTION OF THE DRAWINGS

FIG. 1 is a (a) Schematic of nanocubes with edge length d embedded in the membrane substrate. A supported bilayer exists over glass, while a hybrid phospholipid/alkanethiol bilayer is over the silver nanocubes. (b) Representation of the flow chamber device used in this work. The device is placed in the light path of a spectrophotometer, and allows easy exchange of solution surrounding the substrate. (c) Typical spectrum of a membrane-nanocube substrate, exhibiting the prominent quadripolar LSPR peak, λmax, used to monitor spectral shifts. (d) Schematic showing method for embedding nanocubes on the substrate and deposition of the hybrid and supported bilayers.

FIG. 2 shows (a) Fluorescence recovery after photobleaching (FRAP) experiment of a nanocubemembrane substrate. The lipids bleached by intense illumination in the microscope as seen at t0 diffuse away, restoring the intensity over both supported and hybrid bilayer regions. Inset shows wider view with the magnified region highlighted. (b) Normalized fluorescence recovery of lipids over a nanocube or over glass. An immobile fraction of lipids and limited observation time account for the less than full recovery. Glass and nanocube regions recover according to a single exponentials (black lines) with halflives of 5.6 and 6.3 min, respectively. (c) Peak shift of lipid-coated nanocubes. Polynomial fits of the quadripolar peak of the substrates in buffer before coating by lipids (solid line, with raw data shown as gray dots) and after addition of vesicles containing biotinylated lipids and formation of bilayer/hybrid bilayer on the substrate (dashed line). The substrate is then exposed to 0.03 mg ml⁻¹ bovine serum albumin, resulting in virtually no shift (dotted line). The addition of neutravidin, however, causes a substantial peak shift as the protein binds to biotinylated lipids (dot/dash line). Small vertical marks on the spectra denote the peak maximum (λmax) of each curve.

FIG. 3 is a graph showing YFP unbinding monitored by LSPR peak shift. Observed shift in λmax position compared with t=0 for a nanocube-embedded bilayer with (dark squares) or without (open squares) DOGSNTA-Ni lipids. The line is a least-squares fit of the equation y=A*exp [−t/a]+B*exp [−t/b]+y0 to the data where y is the shift in λmax and t is time. The indicated triangle denotes the observed peak shift upon addition of EDTA, which removes all remaining YFP and defines y0. The remaining terms are found by the fitting procedure. The right-hand axis is the calculated protein density by considering the fluorescence of YFP bound to identical bilayers as outlined in the text.

FIG. 4 is a graph showing change in YFP density monitored by fluorescence. Observed change in density of YFP on bilayers with (dark squares) or without (open squares) DOGS-NTA-Ni headgroup lipids. The line represents a fit as in FIG. 3, with y₀ corresponding to a decrease in YFP density (−21,000 μm⁻²) resulting in loss of all bound protein.

FIG. 5 is a graph showing LSPR peak shift for solutions of varying refractive index. The quadripolar peak shift of a nanocube substrate without lipids for water/glycerol solutions of varying refractive indexes. The four data points (left to right) represent the peak shift from successive injections of 0, 25, 50, and 75 vol % aqueous glycerol solutions. The refractive index of each mixture is estimated by the volume-weighted average of the refractive index of pure water or glycerol (from the CRC Handbook). The line is a least squares linear fit to the data, with a slope of 165 nm RI⁻¹. Washing the substrate with pure water returns the quadripolar peak to its original position (i.e. 0).

FIG. 6 is a graph showing LSPR peak shifts of lipid-coated nanocubes. Shorter alkanethiol chain lengths allow a stronger interaction between the LSPR field and the nearby lipid. This results in a larger shift in the quadripolar resonance peak.

FIG. 7 shows images and graphs of fluorescence recovery after photo-bleaching (FRAP) of nanocubes which are not modified with an alkanethiol SAM. Images of the bilayer with nanocubes before photobleaching (a), immediately after photobleaching (b), and ten minutes later (c). The nanocubes do not recover fluorescence to the same extent as those coated by a SAM after photobleaching, indicating lipid material is not continuous with the surrounding bilayer. (d) Fluorescence recovery of nanoparticle and glass regions of the substrate, analagous to FIG. 2b. Fluorescence of the nanoparticle region recovers much less fully with these non-alkanethiol coated nanoparticles.

FIG. 8 is a graph showing the overlay of LSPR and fluorescence data from FIGS. 3 and 4.The two data sets have very similar unbinding kinetics, which further illustrates that the two systems may be directly compared. The YFP fluorescence-derived surface densities may be mapped to the LSPR data, as used for the right-hand axis of FIG. 3.

FIG. 9 is a graph showing the cone-shaped area which represents the emission profile from a nanocube spread across multiple square pixels.

### DETAILED DESCRIPTION OF THE PREFERRED EMBODIMENT

The present invention provides a sensor for detecting the binding of molecules to membrane surfaces. In one embodiment, the sensor comprising a substrate having a continuous membrane coating, wherein the substrate features nanoparticles disposed between the membrane coating and the substrate. The nano-plasmonic sensing device is intended to have simplicity of fabrication and of readout. In one embodiment, the manufacture of the basic sensor surface is based on a series of solution-based deposition and wash steps, and the readout is using simple absorbance spectrophotometry in an off-the-shelf instrument. The sensor presented herein is potentially easily parallelized for high-throughput applications, which distinguishes it from conventional SPR and related nanomaterial-based sensors.

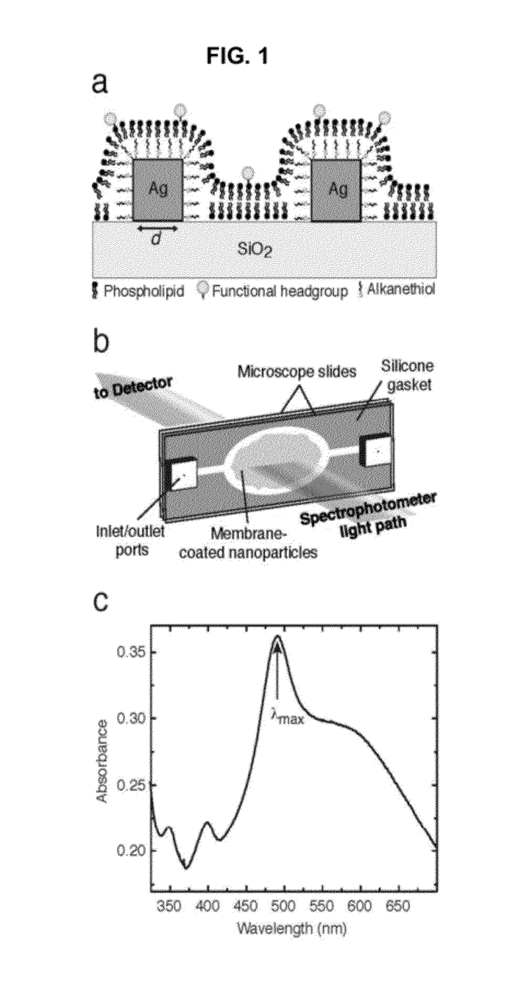

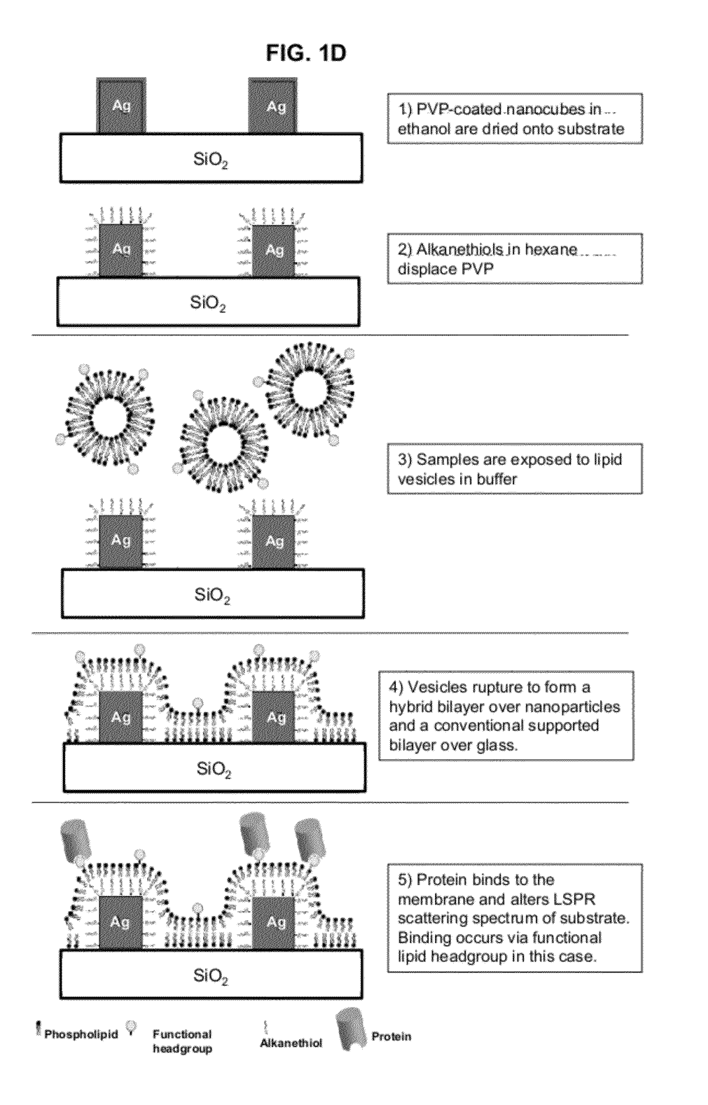

In one embodiment, a multiplexable, label-free sensor device to measure interfacial binding of an analyte at a phospholipid membrane surface. Referring now to FIG. 1A, in one embodiment, the sensor device comprising a substrate that is substantially planar surface having a randomly ordered array of nanoparticles displayed on the surface of the substrate and coated by a hybrid lipid bilayer and surrounded by a normal lipid bilayer surface. The lipids themselves, or biomolecules embedded into the bilayers, determine the analyte specificity of the device. Binding occurs either to the membrane directly, or to membrane-associated biomolecules such as proteins or nucleic acids.

Referring now to FIGS. 1B and 1C, the device can measure binding by exploiting the optical absorbance due to localized surface plasmon resonance (LSPR) scattering by the nanoparticles. The nanoparticle shape provides the LSPR scattering spectrum of sharply defined peaks, the positions of which are dependent on the refractive index of the surrounding environment, and hence to analyte bound to the membrane. Spectral shifts of the peaks indicate binding or unbinding of the analyte to the bilayer surface. The device is easily realized, for example, as a simple flow chamber that may be placed in an absorbance spectrophotometer, where the nanoparticle scattering registers as a distinct absorbance spectrum. Experiments have shown that this device is capable of collecting binding kinetics data as well as specificity measurements, all without depending on potentially disruptive analyte labeling.

While there are academic studies that use surface-based noble metal nanostructures as membrane binding sensors, the present embodiment lacks their burdensome technical requirements such as micropatterning of substrates. In contrast, nanocubes can be synthesized en masse and easily deposited over large areas. This means that this system is potentially easily multiplexed/parallelized and automated. For example, this could be achieved by using our basic technique adapted to a glass-bottomed 96-well plate and read in a plate reader absorbance spectrophotometer. Thus, in another embodiment, the present device provides for methods for detecting an analyte of interest or assays for biodetection.

An instrumental development that enables this invention is the capability of producing defect-free, fluid lipid bilayers that coat the nanoparticles and surrounding glass surface alike. Bilayers will form on glass, mica and some hydrophilic surfaces under a specific range of conditions, and not at all on bare or polymer-coated silver. Any surface contamination on the glass can have detrimental effects on the bilayer. The implementation of this device has required developing a method that allows both the nanoparticle and the glass to be covered with a continuous bilayer (hybrid bilayer on the nanoparticles; standard bilayer over the glass), preserves the environmental sensitivity of the nanoparticles' spectrum, and also allows the LSPR spectrum to be easily interrogated. Additionally, mathematical fitting of the quadripolar LSPR peak allows the accurate determination of the peak maximum beyond the resolution limit of the spectrophotometer. This is necessary for monitoring small shifts in the nanoparticle spectrum. Finally, a small, continuous-flow chamber to contain our experiments enables fluid exchange over the slide surface during data collection, though not all applications may require it.

The substrate for the sensor may comprise materials such as glass, mica, quartz, polydimethylsiloxane (PDMS), polystyrene, silica, SiO₂, MgF₂, CaF₂, polyacrylamide, and various polysaccharides including dextran, agarose, cellulose and modified, crosslinked and derivatized embodiments thereof, and any other materials with constant spectra or any lipid-compatible material, i.e., a bilayer will form on the surface. For example, polymers like PDMS, or substrates like glass that have been decorated with biomolecules which can support lipid membranes (e.g. polymer supported bilayers) {See Tanaka, M.; Sackmann, E. Nature 2005, 437, 656-663, Sackmann, E. Science 1996, 271, 43-48} and can be suitable substrates. SiO₂ is a particularly effective substrate material, and is readily available in the form of glass, quartz, fused silica, or oxidized silicon wafers. These surfaces can be readily created on a variety of substrates, and patterned using a wide range of micro- and nano-fabrication processes including: photolithography, micro-contact printing, electron beam lithography, scanning probe lithography and traditional material deposition and etching techniques.

In another embodiment, the nanoparticles are other polyhedra including but not limited to, nanopyramids, nanobowties, nanorods, nanocrescents, nanotubes, nanowontons, nanodisks, layered nanodisks with an alternating shielding layer, and other nanoscale polyhedra.

The nanoparticles can comprise a metal, a semiconductor material, multi-layers of metals, a metal oxide, an alloy, a polymer, or carbon nanomaterials. In certain embodiments the nanoparticle comprises a metal selected from the group consisting of Ga, Au, Ag, Cu, Al, Ta, Ti, Ru, Ir, Pt, Pd, Os, Mn, Hf, Zr, V, Nb, La, Y, Gd, Sr, Ba, Cs, Cr, Co, Ni, Zn, Ga, In, Cd, Rh, Re, W, Mo, and oxides, and/or alloys, and/or mixtures, and/or nitrides, and/or sintered matrix thereof.

In one embodiment the nanoparticles are silver or gold nanocubes. The remarkably sharp quadripolar resonance peak of silver nanocubes allows us to resolve more subtle variations in the spectrum compared with the very broad scattering signatures of other nanoparticles.

In one embodiment, the nanoparticles can be made according to the methods described in A. Tao, P. Sinsermsuksakul, and P. Yang. Tunable plasmonic lattices of silver nanocrystals. Nature Nanotechnology, 2(7):435-440, July 2007 and A. Tao, P. Sinsermsuksakul, and P. D. Yang. Polyhedral silver nanocrystals with distinct scattering signatures. Angewandte Chemie-International Edition, 45(28):4597-4601, 2006, both of which are hereby incorporated by reference.

Co-pending U.S. patent application Ser. No. 12/151,553, filed on Jul. 21, 2008, entitled, “A Fluid Membrane-Based Ligand Display System for Live Cell Assays and Disease Diagnosis Applications,” hereby incorporated by reference in its entirety, discloses detection of cell phenotypes in an soluble lipid bilayer (SLB) assay using soluble signaling ligands attached to the lipid bilayers. Other SLB assays are described in U.S. Pat. No. 6,228,326, which is incorporated by reference in its entirety. Co-pending U.S. patent application Ser. No. 10/076,727, incorporated by reference in its entirety, describes use of SLB assays to effect and modulate cell adhesion. All these related publications and patent applications are incorporated by reference in their entirety, especially for the purposes of enabling and exemplifying aspects of the present invention that had been developed in previous work conducted by some of the same inventors.

The supported bilayer of the assay system comprises a lipid bilayer wherein the primary ingredient is an egg-phosphatidylcholine (PC) membrane. In the absence of dopants, cells do not adhere to this membrane. Other suitable lipids that do not permit cell adhesion include pure phosphatidylcholine membranes such as dimyrstoyl-phosphatidylcholine or dipalmitoylphosphatidylcholine. Another suitable primary lipid component is phosphatidylethanolamine (PE), which is also, in addition to PC, a primary component.

The lipid composition in the supported lipid bilayer can comprise dopants to vary bilayer properties. Preferred dopant lipids are a negatively, positively or neutrally charged lipid. In one embodiment, the dopant lipid is the negatively charged lipid phosphatidylserine (PS). Other potential dopants can be dipalmitoylphosphatidic acid (PA), distearoylphosphatidylglycerol (PG), phosphatidylinositol,1,2-dioleoyl-3-dimethylamonnium-propane, 1,2 dioleoyl-3-trimethylammonium-propane (DAP), dimethyldioctadecylammonium bromide (DDAB), 1,2-dioleoyl-sn-glycero-3-ethylphosphocholine (ethyl-PC), N-(7-nitrobenz-2-oxa-1,3-diazol-4-yl)-1,2-dihexadecanoyl-sn-glycero-3-phosphoethanolamine ammonium salt (NDB-PE). Suitable neutral lipid dopants include cerebrosides and ceramides. The amount of the dopant is selected based on the property of the dopant. For a lipid dopant, 2 to 10%, up to 20% is preferred.

In a preferred embodiment, the device comprising a glass slide with a randomly ordered array of ˜100 nm wide silver nanocubes {Tao, Angewandte Chemie-International Edition 2006, 45, 4597-4601, Tao, Nature Nanotechnology 2007, 2, 435-440} at ˜10 to 100 cubes/μm² density, coated by a hybrid lipid bilayer and surrounded by a normal lipid bilayer surface (see FIGS. 1A and 1D).

In contrast to other metal nanoparticle-based systems, the data collection technique described measures a signal derived from large populations of nanoparticles, which means particle-to-particle variation in LSPR response is averaged. This helps ensure the comparability of one device to another. Thus, in some embodiments, a population density of ˜10-100 particles/μm² density on a surface is more preferred.

To facilitate simple fabrication of the sensors, a method for fabrication was designed. In one embodiment, the manufacture of the basic sensor surface is based on a series of solution-based deposition and wash steps, and the readout is using simple absorbance spectrophotometry in an off-the-shelf instrument.

Referring now to FIG. 1D(1), a substrate and polymer-coated nanoparticles are provided. In one embodiment, the polymer-coated nanoparticles are coated with a polymer such as polyvinylpyrrolidone and its derivatives. The polymer-coated nanoparticles are dried onto the substrate in a solvent.

In FIG. 1D(2), the polymer coating on the polymer-coated nanoparticles is replaced by a self-assembled monolayer (SAM) by such techniques known in the art as solution deposition, physical vapor depositions, electrodeposition, adsorption or silanization. The nanoparticles are coated with the SAM to provide a chemical link between the nanoparticle surface and the surrounding supported bilayer. In one embodiment, the nanoparticles are coated with an alkanethiol SAM. Other SAM linking molecules are known in the art and can include such molecules as chlorosilanes, disulfides, amines, alcohols, carboxylic acids and phosphonic acids.

In one embodiment, the planar surface is a glass slide, a microfluidic device, or glass surface having a flow chamber to allow the sample suspected of containing an analyte to interact with the membrane-coated device. In another embodiment, rather than the flow chamber, the surface of a glass-bottomed multi-well plate could be used, and thus allowing the assay to be multiplexed and enabling a readout in a plate reader or spectrophotometer.

The nanoparticles may be adsorbed onto other surfaces instead of a substantially planar surface. In one embodiment, the surface is a bead similar to that in copending U.S. patent application Ser. No. 10/581,371, the contents of which are herein incorporated by reference. Specific examples of the particles include polystyrene, cellulose, dextran crosslinked with bisacrylamide (Biogel™, Bio-Rad, U.S.A.), agar, glass beads and latex beads. The beads may be nanometer to micrometer scale in diameter. This would enable LSPR readout of surfaces from suspension rather than on a monolithic surface (e.g., in a cuvette).

Referring now to FIG. 1D(3), the substrate featuring the SAM-covered nanoparticles are exposed to lipid vesicles in buffer, and the vesicles are allowed to rupture to form a hybrid bilayer over the nanoparticles and a conventional supported bilayer over the substrate (FIG. 1D(4)) to create the sensor to detect binding at membrane surfaces. The membranes can be formed by solution deposition of the nanoparticles on the substrate or by other methods known in the art including Langmuir-Blodgett or Langmuir-Schaeffer methods. In one embodiment, the planar supported membranes are formed by fusion of small unilamellar vesicles (SUV) with clean silica substrates according to the methods described in Salafsky, J., J. T. Groves, and S. G. Boxer, Architecture and function of membrane phospholipids in erythrocytes as factor in adherence to endothelial cells in proteins, Biochemistry, 1996, 35: 14773-14781, and U.S. Pat. No. 6,228,326, both of which are hereby incorporated in their entirety.

In another embodiment, a lipid solution in chloroform is evaporated onto the walls of a round bottom flask that is then evacuated overnight. Lipids are resuspended in distilled water by vortexing moderately for several minutes. The lipid concentration at this point should be around 3 mg/ml. The lipid dispersion is then probe sonicated to clarity on ice, yielding small unilamellar vesicles (SUV). The SUVs are purified from other lipid structures by ultracentrifugation for 2 hours at 192,000 g. SUVs are stored at 4° C. and typically are stable for a few weeks to several months. The SUVs are fused onto the aqueous phase on the substrate. The vesicles spontaneously assemble in a matter of seconds to form a continuous single bilayer on the substrate. Excess vesicles are rinsed away while maintaining the membrane bilayer under bulk aqueous solution at all times. In another embodiment, monodisperse lipid vesicles are made by extrusion through a porous filter. For example, vesicles can be prepared by drying lipids dissolved in CHCl₃ in a round bottom flask, then suspending the dried lipid film in water, and repeatedly passing the suspension through a 100 nm pore filter in a high pressure extruder at 50° C. to form the lipid vesicles.

After forming the sensor, the present device can be used in sensing and detection methods. In one embodiment, a method comprising: contacting a target molecule with a substrate having a continuous membrane coating a plurality of nanoparticles disposed between the membrane and the substrate, applying a molecule possibly capable of binding the target molecule, and detecting plasmon generated phenomena at a nanoparticle.

In another embodiment, a method for detecting an analyte of interest comprising the steps of: (a) providing a substrate having a continuous membrane coating, wherein the substrate features nanoparticles disposed between the membrane coating and the substrate, wherein the nanoparticles have a known spectra, and wherein the continuous membrane displays a ligand for the analyte of interest; (b) applying a sample suspected of containing a target analyte of interest to the substrate; (c) detecting plasmon generated phenomena at the nanoparticles, whereby a spectral shift in the known spectra of the nanoparticles indicates that the target analyte is bound to the ligand.

Referring now to FIG. 1D(5), in one embodiment, a protein binds to the membrane and alters LSPR scattering spectrum of substrate. Binding occurs via functional lipid headgroup in this case.

The term “analyte”, “analyte of interest”, or “target analyte” refers to the compound or composition to be detected, including drugs, metabolites, pesticides, pollutants, and the like. The analyte can be comprised of a member of a specific binding pair (sbp) and may be a ligand, which is monovalent (monoepitopic) or polyvalent (polyepitopic), preferably antigenic or haptenic, and is a single compound or plurality of compounds, which share at least one common epitopic or determinant site. The analyte can be a part of a cell such as bacteria or a cell bearing a blood group antigen such as A, B, D, etc., or an HLA antigen or a microorganism, e.g., bacterium, fungus, protozoan, or virus. If the analyte is monoepitopic, the analyte can be further modified, e.g. chemically, to provide one or more additional binding sites. In practicing this invention, the analyte has at least two binding sites.

The term “ligand” refers to any organic compound for which a receptor naturally exists or can be prepared. The term ligand also includes ligand analogs, which are modified ligands, usually an organic radical or analyte analog, usually of a molecular weight greater than 100, which can compete with the analogous ligand for a receptor, the modification providing means to join the ligand analog to another molecule. The ligand analog will usually differ from the ligand by more than replacement of a hydrogen with a bond, which links the ligand analog to a hub or label, but need not. The ligand analog can bind to the receptor in a manner similar to the ligand. The analog could be, for example, an antibody directed against the idiotype of an antibody to the ligand.

The term “receptor” or “antiligand” refers to any compound or composition capable of recognizing a particular spatial and polar organization of a molecule, e.g., epitopic or determinant site. Illustrative receptors include naturally occurring receptors, e.g., thyroxine binding globulin, antibodies, enzymes, Fab fragments, lectins, nucleic acids, nucleic acid aptamers, avidin, protein A, barsar, complement component C1q, and the like. Avidin is intended to include egg white avidin and biotin binding proteins from other sources, such as streptavidin.

The ligand may be an oligonucleotide of ribonucleic acid residues, deoxyribonucleic acid residues, polypeptides, proteins, receptors, carbohydrates, thyroxine binding globulin, antibodies, enzymes, Fab fragments, lectins, nucleic acids, nucleic acid aptamers, avidin, protein A, barsar, complement component C1q, organic or inorganic molecules having a binding affinity for an analyte of interest, or lipid-linked small molecules that are displayed, bound or otherwise attached to the membrane coating the sensor.

The term “specific binding pair (sbp) member” refers to one of two different molecules, which specifically binds to and can be defined as complementary with a particular spatial and/or polar organization of the other molecule. The members of the specific binding pair can be referred to as ligand and receptor (antiligand). These will usually be members of an immunological pair such as antigen-antibody, although other specific binding pairs such as biotin-avidin, enzyme-substrate, enzyme-antagonist, enzyme-agonist, drug-target molecule, hormones-hormone receptors, nucleic acid duplexes, IgG-protein A/protein G, polynucleotide pairs such as DNA-DNA, DNA-RNA, protein-DNA, lipid-DNA, lipid-protein, polysaccharide-lipid, protein-polysaccharide, nucleic acid aptamers and associated target ligands (e.g., small organic compounds, nucleic acids, proteins, peptides, viruses, cells, etc.), and the like are not immunological pairs but are included in the invention and the definition of sbp member. A member of a specific binding pair can be the entire molecule, or only a portion of the molecule so long as the member specifically binds to the binding site on the target analyte to form a specific binding pair.

The term “specific binding” refers to the specific recognition of one of two different molecules for the other compared to substantially less recognition of other molecules. Generally, the molecules have areas on their surfaces or in cavities giving rise to specific recognition between the two molecules. Exemplary of specific binding are antibody-antigen interactions, enzyme-substrate interactions, polynucleotide interactions, and so forth.

The analyte of interest may be nucleic acid molecules, proteins, peptides, haptens, metal ions, drugs, metabolites, pesticide or pollutant. The method can be used to detect the presence of such analytes as toxins, hormones, enzymes, lectins, proteins, signaling molecules, inorganic or organic molecules, antibodies, contaminants, viruses, bacteria, other pathogenic organisms, idiotopes or other cell surface markers. It is intended that the present method can be used to detect the presence or absence of an analyte of interest in a sample suspected of containing the analyte of interest.

In some embodiments, the target analyte is comprised of a nucleic acid and the specific binding complement is an oligonucleotide. Alternatively, the target analyte is a protein or hapten and the specific binding complement is an antibody comprising a monoclonal or polyclonal antibody. Alternatively, the target analyte is a sequence from a genomic DNA sample and the specific binding complement are oligonucleotides, the oligonucleotides having a sequence that is complementary to at least a portion of the genomic sequence. The genomic DNA may be eukaryotic, bacterial, fungal or viral DNA.

In one embodiment, detection of a particular cytokine can be used for diagnosis of cancer. Specific analytes of interest include cytokines, such as IL-2 as shown in the examples. Cytokines are important analytes of interest in that cytokines play a central role in the regulation of hematopoiesis; mediating the differentiation, migration, activation and proliferation of phenotypically diverse cells. Improved detection limits of cytokines will allow for earlier and more accurate diagnosis and treatments of cancers and immunodeficiency-related diseases and lead to an increased understanding of cytokine-related diseases and biology, because cytokines are signature biomarkers when humans are infected by foreign antigens.

Chemokines are another important class of analytes of interest. Chemokines are released from a wide variety of cells in response to bacterial infection, viruses and agents that cause physical damage such as silica or the urate crystals. They function mainly as chemoattractants for leukocytes, recruiting monocytes, neutrophils and other effector cells from the blood to sites of infection or damage. They can be released by many different cell types and serve to guide cells involved in innate immunity and also the lymphocytes of the adaptive immune system. Thus, improved detection limits of chemokines will allow for earlier and more accurate diagnosis and treatments, i.e. for bacterial infections and viral infections.

In some embodiments, the target analyte may be a variety of pathogenic organisms including, but not limited to, sialic acid to detect HIV, Chlamydia, Neisseria meningitides, Streptococcus suis, Salmonella, mumps, newcastle, and various viruses, including reovirus, sendai virus, and myxovirus; and 9-OAC sialic acid to detect coronavirus, encephalomyelitis virus, and rotavirus; non-sialic acid glycoproteins to detect cytomegalovirus and measles virus; CD4, vasoactive intestinal peptide, and peptide T to detect HIV; epidermal growth factor to detect vaccinia; acetylcholine receptor to detect rabies; Cd3 complement receptor to detect Epstein-Barr virus; β-adrenergic receptor to detect reovirus; ICAM-1, N-CAM, and myelin-associated glycoprotein MAb to detect rhinovirus; polio virus receptor to detect polio virus; fibroblast growth factor receptor to detect herpes virus; oligomannose to detect Escherichia coli; ganglioside G_{M1} to detect Neisseria meningitides; and antibodies to detect a broad variety of pathogens (e.g., Neisseria gonorrhoeae, V. vulnificus, V. parahaemolyticus, V. cholerae, and V. alginolyticus).

In some embodiments, multiple analytes of interest can be detected by utilizing multiple ligands specific to different analytes of interest and utilizing distinct barcode oligonucleotides corresponding to each analyte of interest.

The analyte of interest may be found directly in a sample such as a body fluid from a host. The host may be a mammal, reptile, bird, amphibian, fish, or insect. In a preferred embodiment, the host is a human. The body fluid can be, for example, urine, blood, plasma, serum, saliva, semen, stool, sputum, cerebral spinal fluid, tears, mucus, pus, phlegm, and the like. The particles can be mixed with live cells or samples containing live cells.

Where the sample is live cells or samples containing live cells, a cell surface protein or other molecule may serve as the analyte of interest. This allows for the detection of cell activation and proliferation events, cellular interactions, multiplexing, and other physiologically relevant events

The target molecule binding as well as target molecule adhesion to a cell can be detected by any method of detection including but not limited to detection by absorbed light, reflected light, scattered light, back reflected interference fringes, or scattered reflected intergerence fringes, light from resonant energy transfer energy of the plasmonic field coupled to flourophores (like flourescence resonance energy transfer).

In another embodiment, the sensor can be an array of individually addressable regions of substrate (e.g., wells in a microwell plate, or channels in a microfluidic chip) to form a multiplex assay that allows testing different events in different wells, or channels.

In one embodiment, absorbance or reflectance spectra of the entire substrate is measured. The image and spectrum of the sensor can be acquired using a dark-field microscopy system with a true-color imaging camera and a spectrometer. For example, the microscopy system can consist of a Carl Zeiss Axiovert 200 inverted microscope (Carl Zeiss, Germany) equipped with a darkfield condenser (1.2<NA<1.4), a true-color digital camera (CoolSNAP cf, Roper Scientific, NJ), and a 300 mm focal-length and 300 grooves/mm monochromator (Acton Research, MA) with a 1024×256-pixel cooled spectrograph CCD camera (Roper Scientific, NJ). After photobleaching the fluorescence, the true-color scattering images of the nanoparticles are taken using a 60× objective lens (NA=0.8) and the true-color camera with a white light illumination from a 100 W halogen lamp.

In another embodiment, rather than measuring the absorbance spectrum of the entire substrate, interrogation of individual nanoparticles or regions/clusters of nanoparticles is contemplated. Moreover the sensor could record scattered light instead of an absorbance spectrum. The scattering spectra of the nanoparticles can be taken using the same optics, but they are routed to the monochromator and spectrograph CCD. Furthermore, a 2 μm-wide aperture can be placed in front of the entrance slit of the monochromator to keep only a single nanoparticle in the region of interest.

Raw spectra are normalized with respect to the spectrum of a non-resonant nanoparticle (i.e., polystyrene) after the background subtraction. In the spectroscopy experiments, the nanoparticle-immobilized glass slide can be mounted on a transparent ITO heater with an external thermostat. The immobilized membranes and nanoparticles are immersed in a drop of buffer solution which also serves as the contact fluid for the dark-field condenser. The distance between the condenser and nanoparticles can be ˜1-2 mm. The sample suspected of containing an analyte to be detected can be loaded by pipette into the contact fluid and the continuous spectrum acquisition started simultaneously. The microscopy system can be completely covered by a dark shield, which prevents ambient light interference and serious evaporation of the sample.

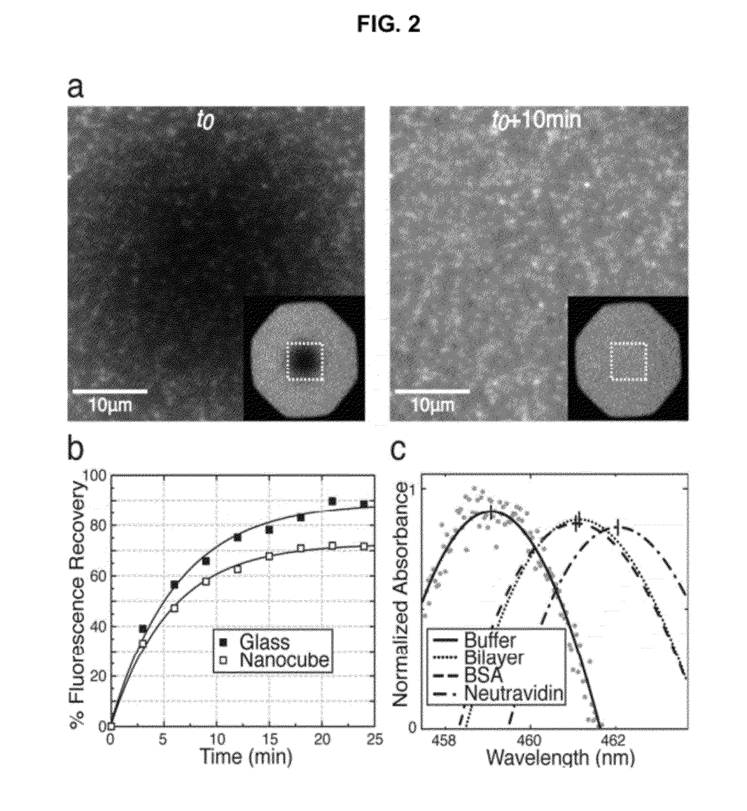

Normalized fluorescence recovery of lipids over a nanocube or over glass is shown in FIG. 2. An immobile fraction of lipids and limited observation time account for the less than full recovery. Glass and nanocube regions recover according to a single exponentials (black lines) with halflives of 5.6 and 6.3 min, respectively. When the nanocubes are functionalized with alkanethiol prior to formation of the supported bilayer, these enhanced regions of fluorescence bleach and recover in the same timescale as the bulk of the supported membrane. Polynomial fits of the quadripolar peak of the substrates in buffer before coating by lipids and after addition of vesicles containing lipids doped with a ligand and formation of bilayer/hybrid bilayer on the substrate can be performed as baseline for comparison. The membrane-coated substrate is then exposed to 0.03 mg ml⁻¹ bovine serum albumin, resulting in virtually no shift. The addition of a sample containing an analyte that binds to the ligand, however, should cause a substantial peak shift as the analyte binds to the ligand.

Application of wash steps or an agent to cause unbinding of the analyte from the ligand can also be performed to allow monitoring of LSPR peak shift. Observed shift in λmax position compared with t=0 for a nanoparticle-embedded bilayer with or without the analyte bound or with or without the ligands present in the lipid membrane. In one embodiment, the line is a least-squares fit of the equation y=A*exp [−t/a]+B*exp [−t/b]+y0 to the data where y is the shift in λmax and t is time. The observed peak shift upon addition of an agent which removes all remaining remaining analyte and defines y0. The remaining terms are found by the fitting procedure.

To measure small shifts in the LSPR-derived absorbance spectrum of the sensor resulting from molecular binding, the quadripolar absorbance peak is fit to a 5^{th} order polynomial function over a consistent sampling range. This allows the precise determination of peak maximum position, and in the present implementation at least 0.02 nm resolution is achieved, as discussed below. In contrast to previous examples of this approach, changes in the peak maximum position (λₘₐₓ, FIG. 1c) are monitored rather than changes in the peak centroid position[Nenninger, G. G.; Piliarik, M.; Homola, J. Measurement Science and Technology 2002, 13, 2038-2046] or its absorbance[Dahlin, A. B.; Tegenfeldt, J. O.; Hook, F. Analytical Chemistry 2006, 78, 4416-4423], both of which give less consistent data here. This is partly because the arrays of nanoparticles are randomly ordered, and the density of particles can vary from one array to another as well as on a single substrate. The resulting variance in particle density has a greater impact on the absolute absorbance of the quadripolar peak than its position, and considering peak position alone allows for simpler comparisons between sensor substrates

In one embodiment, the analyte density is calculated by considering the fluorescence of the analyte bound to identical bilayers as herein described and in Galush et al. Biophys J, 2008, which is hereby incorporated by reference, and demonstrated by the Examples infra. Furthermore, other ways to calibrate the analyte density can be employed. For example, instead of fluorescence, one could use mass standards. In one instance, another protein binding in known amounts to the same or identical substrate can be calculated.

In another embodiment, sensor response could be measured by localizing the spectrum peak by position of maximum signal, position of centroid, or absolute intensity (spectrum height). The sensor response could be measured by monitoring the increase in fluorescence emission of the analyte upon binding to the membrane. This is what accounts for the bright appearance of the nanoparticles in FIG. 2a, and is shown in FIG. 9.

In yet another embodiment, darkfield microscopy of the whole substrate, portions of the substrate, or individual particles could be used as the readout.

In another embodiment, for real-time plasmon resonance sensing of molecular binding or interactions, the continuous acquisition of the scattering spectrum of a selected nanoparticle starts in synchronization with the introduction of the sample suspected of containing the analyte. For example, one spectrum is taken every minute with a 10-second integration time. The plasmon resonance wavelength data exhibits a first-order exponential decay. Calibration curves generated by plasmon resonance sensing of multiple analytes can be generated and typical scattering spectra and plasmon resonance peak wavelengths of the nanoparticle after the interactions and reactions with multiple analytes can be acquired. In one embodiment, the curve is fit from a semi-empirical model using a Langevin-type dependence of the refractive index vs. amount of unbound ligand or analyte.

And in another embodiment, surface enhanced Raman spectroscopy (SERS) can be used to perform the detection and the readout instead of absorbance (see {McFarland:2005, Porter:2008}). A typical SERS experimental system configuration comprising a microscopy system with Raman spectrometer used to acquire Raman scattering spectra from single tagged nanoplasmonic resonators. In a preferred embodiment, the system is comprised of inverted microscope equipped with a digital camera and a monochromator with a spectrograph CCD camera, a laser source and an optical lens. In one embodiment, Raman spectra can be measured using a modified inverted microscope, such as the Carl Zeiss Axiovert 200 (Carl Zeiss, Germany), with a 50× objective in a backscattering configuration. The laser wavelength can be in the visible and near infrared region. In a preferred embodiment, a 785 nm semiconductor laser is used as the excitation source of Raman scattering, and the laser beam is focused by a 40× objective lens on the NPR. The 785 nm or other near infrared light source can assure less absorption by the biological tissue and lower fluorescence background. However, for certain applications, lower wavelength excitation light might be more advantageous, and even UV light excitation can be used for applications. The excitation power can also be measured by a photometer to insure an output of ˜0.5 to 1.0 mW. The Raman scattering light is then collected through the same optical pathway through a long-pass filter and analyzed by the spectrometer. The Raman spectrometer is preferably linked to a computer whereby the spectrometer can be controlled and the spectra can be obtained and a spectrograph can be observed. The spectral detection can be done with ordinary spectral polychrometer and cooled CCD camera. In an embodiment where the ligands and analytes are nucleotides, the monitored wavenumbers of Raman peaks can range from 400 cm⁻¹ to 2000 cm⁻¹.

In one embodiment, the sensor is incubated with a sample suspected of containing the biomolecule to be detected, preferably in a closed transparent microchamber. The microchamber is mounted on a 37° C. thermal plate on an inverted Raman microscope with darkfield illumination for nanoparticle visualization. The nanoparticles are visualized using the darkfield illumination from oblique angles as the bright dots. The excitation laser is focused on the nanoparticles by a microscopy objective lens. A SERS signal is collected by the same objective lens and analyzed by a spectrometer.

### Additional Applications

In some embodiments, the sensor can be used to measure supported bilayer formation or change in supported bilayer physical properties, in aggregate or on a microscopic scale.

In another embodiment, the sensor can be used to quantify cell adhesion to the substrate mediated by a membrane-resident molecule. As cells tightly bind to the surface and closely adhere, this should change the LSPR scattering signature. In another embodiment, the sensor can be used to monitor lipid vesicle/micelle/bicelle binding.

In some embodiments, using a microscope, we could address different regions of the substrate independently. This could be on the single- or multi-nanoparticle scale. This could be done using darkfield microscopy, or localized illumination or scattering sensor to see the LSPR signature. Notably, SPR is not spatially resolved, whereas our technique can be.

The present sensor is not bound by the described applications but is contemplated to find use in sensing and detection in various SPR methods and devices.

### EXAMPLE 1

### A Nanocube-Plasmonic Sensor

A multiplexable, label-free sensor device to measure interfacial binding of an analyte at a phospholipid membrane surface was made comprising a glass slide with a randomly ordered array of ˜100 nm wide silver nanocubes{Tao:2006,Tao:2007} (at ˜10-100 cubes/μm² density), coated by a hybrid lipid bilayer and surrounded by a normal lipid bilayer surface (see FIG. 1). The silver nanocubes are made according to the methods described in A. Tao, P. Sinsermsuksakul, and P. Yang. Tunable plasmonic lattices of silver nanocrystals. Nature Nanotechnology, 2(7):435-440, July 2007, and] A. Tao, P. Sinsermsuksakul, and P. D. Yang. Polyhedral silver nanocrystals with distinct scattering signatures. Angewandte Chemie-International Edition, 45(28):4597-4601, 2006, both of which are hereby incorporated by reference for all purposes. The lipids themselves, or biomolecules embedded into the bilayers, determine the analyte specificity of the device. Binding occurs either to the membrane directly, or to membrane-associated biomolecules such as proteins or nucleic acids.

The device measures binding by exploiting the optical absorbance due to localized surface plasmon resonance (LSPR) scattering by the silver nanocubes. The LSPR scattering spectrum of nanocubes has sharply defined peaks, the positions of which are dependent on the refractive index of the surrounding environment, and hence to analyte bound to the membrane. Silver nanocubes exhibit a sharp quadripolar LSPR peak that provides a sensitive gauge of the refractive index in the immediately surrounding environment, and have been characterized both experimentally and theoretically[Tao, A. et al, Angewandte Chemie-International Edition 2006, 45, 4597-4601, Tao, A. et al., Nature Nanotechnology 2007, 2, 435-440, Sherry, L. J.; Chang, S. H.; Schatz, G. C.; Van Duyne, R. P.; Wiley, B. J.; Xia, Y. N. Nano Letters 2005, 5, 2034-2038]. At the quadripolar LSPR wavelength, the electromagnetic field exhibits localized hot spots of amplified intensity which extend approximately 10 nm beyond the metal surface, with the field being strongest along the edges and corners of the cube[Sherry, L. J.; et al., Nano Letters 2005, 5, 2034-2038]. This results in less influence from solution components when compared with conventional surface plasmon resonance, which has far longer (200 nm) field penetration depths [Jung, L.; Campbell, C.; Chinowsky, T.; Mar, M.; Yee, S. Langmuir 1998, 14, 5636-5648, Zhou, Y.; Xu, H.; Dahlin, A. B.; Vallkil, J.; Borrebaeck, C. A. K.; Wingren, C.; Liedberg, B.; Hook, F. Biointerphases 2007, 2, 6-15]. The nanocube LSPR field still extends beyond the approximately 5 nm thickness of the hybrid bilayer[Leonenko, Z. V.; Finot, E.; Ma, H.; Dahms, T. E. S.; Cramb, D. T. Biophysical Journal 2004, 86, 3783-3793] to allow probing of binding at the membrane surface

Spectral shifts of the peaks indicate binding or unbinding of the analyte to the bilayer surface. The device is easily realized as a simple flow chamber that may be placed in an absorbance spectrophotometer, where the nanoparticle scattering registers as a distinct absorbance spectrum. Experiments have shown that this device is capable of collecting binding kinetics data as well as specificity measurements, all without depending on potentially disruptive analyte labeling.

The construction of the biosensor begins with drying a solution of silver nanocubes onto a glass substrate. The nanocubes are synthesized using the polyol method[Tao, A.; Sinsermsuksakul, P.; Yang, P. D. Angewandte Chemie-International Edition 2006, 45, 4597-4601; Fievet, F.; Lagier, J. P.; Blin, B.; Beaudoin, B.; Figlarz, M. Solid State Ionics 1989, 32-33, 198-205, and Sun, Y.; Xia, Y. Science 2002, 298, 2176-2179], capped with poly(vinylpyrrolidone) (PVP), and stored in ethylene glycol for extended periods of time (up to months) before use. Nanocubes are first washed extensively with ethanol to remove residual synthetic reagents. A small droplet of the colloidal suspension is spread onto a glass microscope slide, which has been previously cleaned in a 1:4 30% H₂O₂:H₂SO₄ mixture of piranha solution (extremely reactive, use caution). The droplet is allowed to dry under a N₂ atmosphere for ten minutes; air exposure is minimized to avoid silver oxidation. Slides are then incubated in a hexane solution with 3 mM 1-octanethiol for at least 12 hours to form an alkanethiol self assembled monolayer (SAM) over the metal. The slides are subsequently rinsed by immersion in acetone, isopropanol, and twice in deionized water. After drying under N₂ for 30 minutes, the nanoparticle-covered slides are assembled into a flow chamber using a silicone gasket (Invitrogen) and a second slide with holes cut to allow solution exchange within the device (FIG. 1b). Measurements are conducted using regions of substrates with nanocube densities of approximately 10 to 100 μm⁻², as estimated by darkfield microscopy.

The extinction spectrum of a nanocube-decorated substrate, as monitored by a standard spectrophotometer (Cary 100), is illustrated in FIG. 1c. The spectrum is dominated by a large peak with a maximum at λₘₐₓ corresponding to the quadripolar LSPR of the nanocubes[Tao, A.; Sinsermsuksakul, P.; Yang, P. D. Angewandte Chemie-International Edition 2006, 45, 4597-4601]. At these densities, some nanocubes interact to form aggregates that appear as brighter spots by darkfield microscopy (not shown) and in fluorescence images following coating by lipid membranes containing fluorophores for characterization (discussed below and shown in FIG. 2a). The large area illuminated by the spectrophotometer (˜0.5 cm²) averages the response from ˜10⁸-10⁹ nanocubes, with many apparently remaining as singular particles as judged by the aggregate extinction spectrum. The resulting integrated signal from the ensemble of nanocubes may reduce absolute sensitivity compared with individual particle scattering spectra, as has been argued[Anker, J. N.; Hall, W. P.; Lyandres, O.; Shah, N. C.; Zhao, J.; Van Duyne, R. P. Nature Materials 2008, 7, 442-453], but it greatly simplifies the comparison of different substrate preparations, since ensemble averages are far more consistent than the individual particle properties. This latter point proves enabling in the present application.

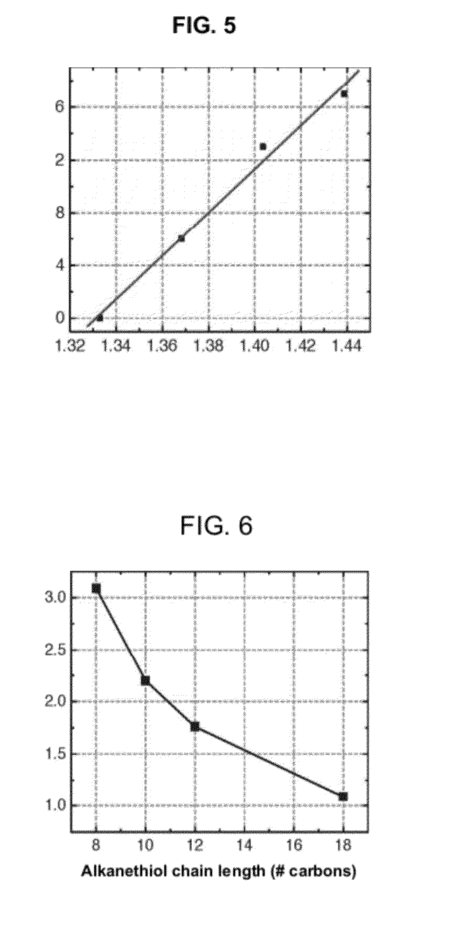

It is possible to directly measure the response of SAM-coated nanocubes to changes in the surrounding refractive index (RI) by exposing the sensor to aqueous solutions of glycerol and tracking the shift in position of λₘₐₓ relative to its initial wavelength in water alone. A plot of the shift of the peak versus the refractive index of the surrounding glycerol/water solution yields a sensitivity of 165 nm RI⁻¹ (FIG. 5). This is comparable to the ˜180-220 nm RI⁻¹ sensitivity reported for nanometric holes filled with lipid vesicles in a metal film on glass[Dahlin, A. B.; Jonsson, M. P.; Hook, F. Advanced Materials 2008, 20, 1436-+.], though less than that of microfabricated metal nanostructures directly interacting with the solvent[Hicks, E. M.; Zhang, X.; Zou, S.; Lyandres, O.; Spears, K. G.; Schatz, G. C.; Van Duyne, R. P. The Journal of Physical Chemistry B 2005, 109, 22351-22358]. It is likely that further optimization of nanocube homogeneity and deposition procedures can increase the observed value. Also, since the evanescent field surrounding the nanocube decays strongly with distance, some of the potential sensitivity of the nanocube substrates may be lost due to the alkanethiol/phospholipid coating. Indeed, shorter chain-length alkanethiol SAMs yield larger peak shifts in response to coating by lipids (FIG. 6) as described below. The focused sensitivity is, however, an advantage when the actual targets for sensing are molecular monolayers.

To form a phospholipid membrane on the nanocube-coated substrate, the flow chamber is filled with 50 mM Tris, 200 mM NaCl, pH 7.5 buffer and allowed to incubate for 30 minutes before rinsing with further buffer to remove loosely adhered particles. A solution of lipid vesicles is injected into the flow chamber in the Tris buffer and allowed to incubate for an additional 30 minutes (shorter incubations than these are also likely sufficient). During this time, vesicles rupture to form a supported phospholipid bilayer over the bare glass regions and a phospholipid monolayer over the alkanethiol-modified nanocubes (FIG. 1D). The bilayer and monolayer portions of the membrane are continuous, since lipids diffuse freely over the entire substrate as verified by experimental observations described below. This structure is similar to that of other hybrid bilayer membrane systems[Meuse, C. W.; Niaura, G.; Lewis, M. L.; Plant, A. L. Langmuir 1998, 14, 1604-1611; Kastl, K.; Ross, M.; Gerke, V.; Steinem, C. Biochemistry 2002, 41, 10087-10094; and Jackson, B. L.; Nye, J. A.; Groves, J. T. Langmuir 2008, 24, 6189-6193]. Excess vesicles remaining on the substrate are washed away with several milliliters of 25 mM Tris, 100 mM NaCl, pH 7.5. The vesicles consist primarily of 1,2-dioleoylphophotadylcholine (DOPC) along with 0.5 mol % Texas Red 1,2-dihexadecanoyl-sn-glycero-3-phosphoethanolamine (TR-DHPE, for fluorescence imaging) as well as 10 mol % of (DOGS-NTA-Ni) or 3 mol % 1,2-dipalmitoyl-sn-glycero-3-phosphoethanolamine-N-(biotinyl) (biotin-PE) as indicated (TR-DHPE from Invitrogen; all others from Avanti Polar Lipids). Vesicles are prepared by drying lipids dissolved in CHCl₃ in a round bottom flask, suspending the dried lipid film in water, and repeatedly passing the suspension through a 100 nm pore filter in a high pressure extruder at 50° C.

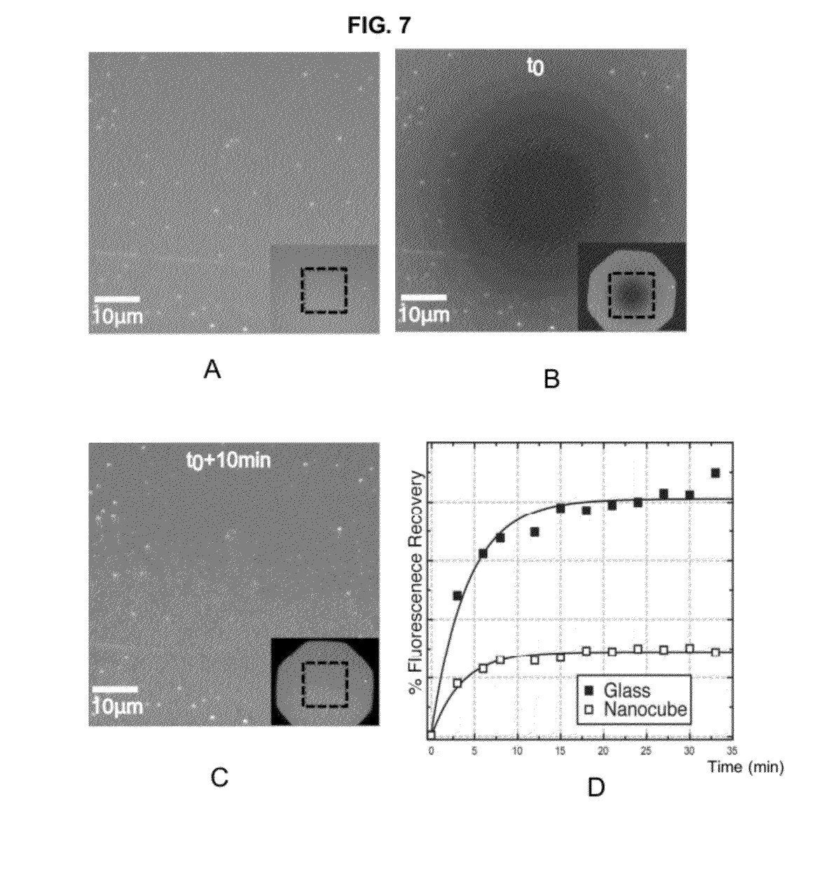

Coating the nanocubes with an alkanethiol SAM is required to create a laterally fluid, continuous membrane over the glass and metal substrate surface. This is demonstrated by fluorescence recovery after photobleaching (FRAP) experiments, where fluorophores in a small region of the substrate surface are bleached under high intensity illumination in a microscope and recover with time due to the lateral diffusion of membrane components (FIG. 2a). The nanocubes are clearly visible in the fluorescence images due to fluorescence enhancement, discussed below. Notably, when the nanocubes are functionalized with alkanethiol prior to formation of the supported bilayer, these enhanced regions of fluorescence bleach and recover in the same timescale as the bulk of the supported membrane. This confirms that lipids in the range of the nanocube surface plasmon are diffusively connected to the rest of the membrane (FIG. 2b). When the nanocubes are not functionalized with alkanethiol SAMs, the surface and initial (t₀) FRAP images look qualitatively the same by microscopy, but the fluorescence of the nanocubes does not recover with time (FIG. 7). This illustrates that the lipid material on nanocubes that remain uncoated by an alkanethiol SAM is not continuous with the surrounding bilayer medium. Similar phenomena are well known in patterned metal/glass surfaces, and have been used as a method of patterning lipid membranes[Groves, J. T.; Ulman, N.; Boxer, S. G. Science 1997, 275, 651-653, Groves, J. T.; Ulman, N.; Cremer, P. S.; Boxer, S. G. Langmuir 1998, 14, 3347-3350]. The observation that nanocubes without SAM coating do produce fluorescence enhancement but do not recover provides confirmatory evidence that the enhancement seen from SAM-coated nanocubes is resulting from lipids on the nanocube itself and not the surrounding bilayer. The schematic sketch in FIG. 1 is based on this experimental evidence. It should also be noted that while defects in the membrane are sure to exist, we know that they are of insufficient density to significantly interfere with long-range diffusive transport.

### EXAMPLE 2

### Detecting Molecular Binding with a Nanocube-Plasmonic Sensor

The nanocubes are seen clearly in fluorescence microscopy images as objects that appear brighter than the surrounding fluorescent supported bilayer (FIG. 2a). There are several potential causes for the high relative fluorescence intensity. Nanocubes provide an excess of local surface area compared to the flat substrate. However, the nanocubes are approximately 4-fold brighter than would be expected based purely on the geometry of a monolayer-coated 100 nm cube (see FIG. 9). One explanation for this is that it is possible for fluorophores to energetically couple to nearby plasmonic fields, resulting in a localized enhancement of fluorescence intensity, even for fluorophores without good spectral overlap between their excitation spectrum and the plasmonic scattering profile[Haes, A.; Zou, S.; Zhao, J.; Schatz, G.; VanDuyne, R. Journal of the American Chemical Society 2006, 128, 10905-10914; Zhang, J.; Fu, Y.; Chowdhury, M. H.; Lakowicz, J. R. Journal of Physical Chemistry C 2008, 112, 9172-9180]. Another possible contributor to the increased intensity is high local concentrations of lipidated fluorophores induced by the metal surface potential, the high local curvature of the membrane on the nanocube, and differences in lipid surface density, as is observed in other membrane systems[Sanii, B.; Parikh, A. N. Soft Matter 2007, 3, 974-977]. All these factors may exist simultaneously, but are not distinguishable here and do not affect the sensing technique, which is not fluorescence-based.

To measure small shifts in the LSPR-derived absorbance spectrum of the sensor resulting from molecular binding, the quadripolar absorbance peak is fit to a 5^{th} order polynomial function over a consistent sampling range. This allows the precise determination of peak maximum position, and in the present implementation at least 0.02 nm resolution is achieved, as discussed below. In contrast to previous examples of this approach, changes in the peak maximum position (λₘₐₓ, FIG. 1c) are monitored rather than changes in the peak centroid position[Nenninger, G. G.; Piliarik, M.; Homola, J. Measurement Science and Technology 2002, 13, 2038-2046] or its absorbance[Dahlin, A. B.; Tegenfeldt, J. O.; Hook, F. Analytical Chemistry 2006, 78, 4416-4423], both of which give less consistent data here. This is partly because the arrays of nanoparticles are randomly ordered, and the density of particles can vary from one array to another as well as on a single substrate. The resulting variance in particle density has a greater impact on the absolute absorbance of the quadripolar peak than its position, and considering peak position alone allows for simpler comparisons between sensor substrates.

As FIG. 9 shows, an individual nanocube is smaller than the area corresponding to a single pixel on the microscope camera. Its emission, however, is distributed across several pixels according to the point spread function of the microscope. This is illustrated by the cone-shaped function in the figure, which is the emission profile from the cube spread across multiple square pixels. The fractional extra intensity of the nanocube above and beyond that of the surrounding bilayer, I_{excess} is

$${I}_{excess} = \frac{{\sum }_{{x}_{n} , {y}_{m}} ( {I}_{x , y} - {I}_{background} )}{{I}_{background}} \qquad ( 1 )$$

whereI_{x,y} is the local intensity of each pixel over a n×m region that completely encompasses the emission of the nanocube, and I_{background} is the average intensity of the bilayer in an area with no nanocubes.

The fractional excess surface area of membrane contained in the pixel in question, A_{excess} is,

$${A}_{excess} = 1 + \frac{( \frac{1}{2} \cdot 5 - 1 ) \cdot {A}_{nanocube}}{{A}_{pixel}} \qquad ( 2 )$$

where A_{nanocube} is the area of the face of an individual nanocube and Aₚᵢₓₑₗ is the calibrated size of each pixel. The excess area is thus the sum of the five exposed faces of the nanocube modified for the fact each has only half the number of lipids as a bilayer, less the area of the glass substrate being occupied by the nanocube. This is expressed as a fraction of the area of the pixel containing the nanocube.

The excess brightness associated with the nanocube is I_{excess}/A_{excess}, which is found to be 4±1 for the ≈100 nm nanocubes used here. This represents the average of 1694 individual nanocubes from multiple sample substrates. Notably, even if all fluorophores were localized to the upper leaflet of the membrane, there is still an excess of fluorescence (2-fold, in this case) compared with what would be expected in this analysis.

The level of nonspecific binding to the membrane-nanocube substrates is extremely low compared with some previous reports of LSPR-based membrane binding sensors[Baciu, C. L.; Becker, J.; Janshoff, A.; Sonnichsen, C. Nano Letters 2008, 8, 1724-1728]. As seen in FIG. 2c, coating an alkanethiol-modified nanocube substrate with phospholipids (96.5% DOPC, 3% biotin-cap-PE, 0.5% TR-DHPE) results in a 2.40 nm shift in the quadripolar peak. Subsequent addition of 0.03 mg ml⁻¹ bovine serum albumin barely shifts the peak position by a further 0.03 nm. Conversely, the addition of neutravidin, which specifically binds to biotin-headgroup lipids incorporated into this membrane composition, results in a 1.26 nm shift. This constitutes a signal/noise ratio of 42 over nonspecific binding.

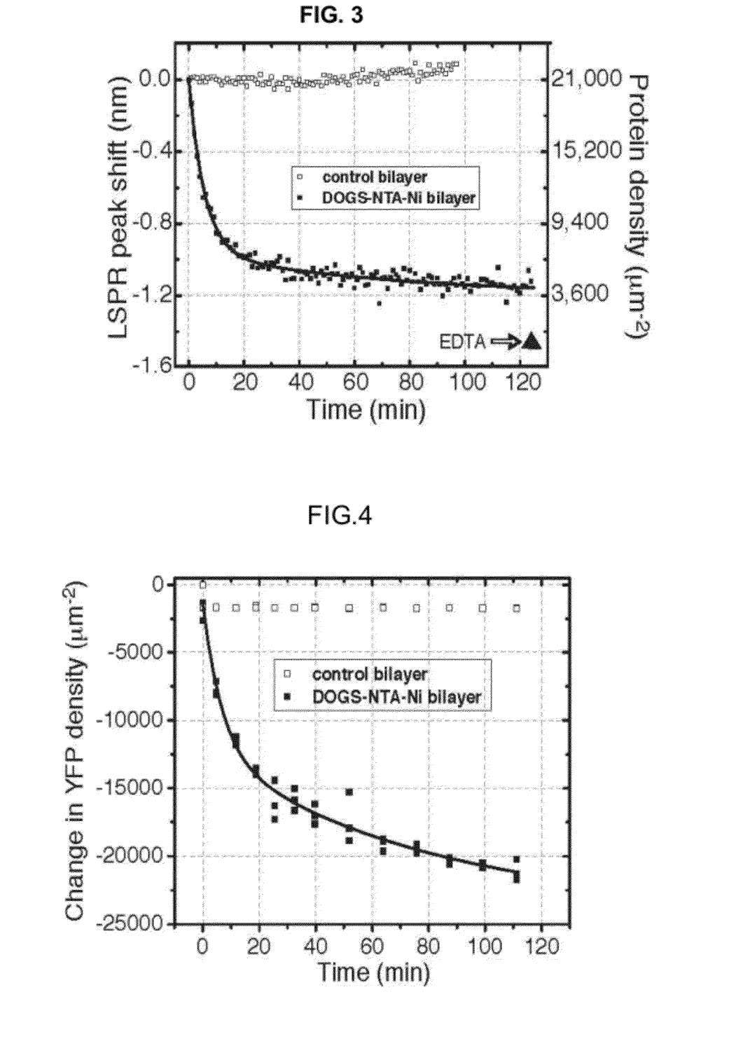

Molecular binding to the membrane surface can also be monitored dynamically, enabling kinetic analyses. In the example considered here, DOGS-NTA-Ni lipids provide the binding functionality—a membrane receptor for these purposes—in a membrane mixture of 89.5% DOPC, 10% DOGS-NTA-Ni, and 0.5% TR-DHPE. The DOGS-NTA-Ni lipids bind to a hexahistidine tag at the C-terminus of yellow fluorescent protein (YFP)[ Ormö, M.; Cubitt, A. B.; Kallio, K.; Gross, L. A.; Tsien, R. Y.; Remington, S. J. Science 1996, 273, 1392-1395]. Other membrane-associated species including membrane proteins, DNA/RNA, or lipid-conjugated small molecules can also be readily used in this configuration[Salafsky, J.; Groves, J. T.; Boxer, S. G. Biochemistry 1996, 35, 14773-14781, Yoshina-Ishii, C.; Boxer, S. G. Journal of the American Chemical Society 2003, 125, 3696-3697, and Parthasarathy, R.; Groves, J. T. Proceedings of the National Academy of Sciences of the United States of America 2004, 101, 12798-12803]. The graph in FIG. 3 (dark squares) shows the shift in the LSPR peak position, λₘₐₓ, as YFP unbinds from a DOGS-NTA-Ni functionalized membrane. The LSPR shift is directly related to protein density (right axis) by the fluorescence of YFP, as discussed below. The unbinding follows a biexponential decay with halflives of 6.3±0.3 and 320±40 min, measured by the shift in LSPR peak position. The error reported for these and similar desorption fits is determined by the uncertainty of a least squares fit to a biexponential decay model performed in OriginPro (OriginLabs). These results are consistent with previous characterizations of protein/DOGS-NTA-Ni membrane binding which show that polyhistidine-tagged proteins exist in both loosely bound and tightly bound states. The two binding states result in two characteristic desorption timescales, the shorter of which is independent of DOGS-NTA-Ni density and has previously been measured to be ˜6 min for other hexahistidine proteins[Nye, J. A.; Groves, J. T. Langmuir 2008, 24, 4145-4149]. In the absence of DOGS-NTA-Ni lipids, the supported membrane strongly resists nonspecific adsorption of the YFP protein and no substantial peak shift is seen (FIG. 3, open squares). The time resolution of these kinetic measurements is determined only by the acquisition rate of the spectrophotometer. In this case it is ˜50 s per spectrum, but much faster rates are possible, since the scattering-based readout means one may simply raise illumination intensity to increase signal strength and acquisition speed.

The LSPR-based measurements are compared to fluorescence from YFP on the membrane surface, which is directly monitored by microscopy in a glass-bottomed 96 well plate format (Nalge-Nunc). This configuration is chosen to compare the data from the nanocube hybrid membranes to conventional supported membranes without nanocubes. Membranes are of the same compositions as those used with the LSPR measurements, and are formed similarly as described elsewhere[Nye, J. A.; Groves, J. T. Langmuir 2008, 24, 4145-4149]. After loading with YFP, fluorescence microscopy images are taken of different regions of several replicate bilayers over the course of time, with manual rinsing of wells between each image acquisition (Nikon TE-300 equipped with a high pressure Hg lamp and Chroma 31001 filter set). The intensity of the fluorescence microscopy images is proportional to the amount of YFP on the surface. These data show that YFP desorbs from the membrane biexponentially with halflives of 7±1 and 80±8 min⁻¹ (FIG. 4), which essentially agrees with the LSPR-based measurements. Variation in the longer halflives may result from the slightly different experimental configurations used for experimental convenience.

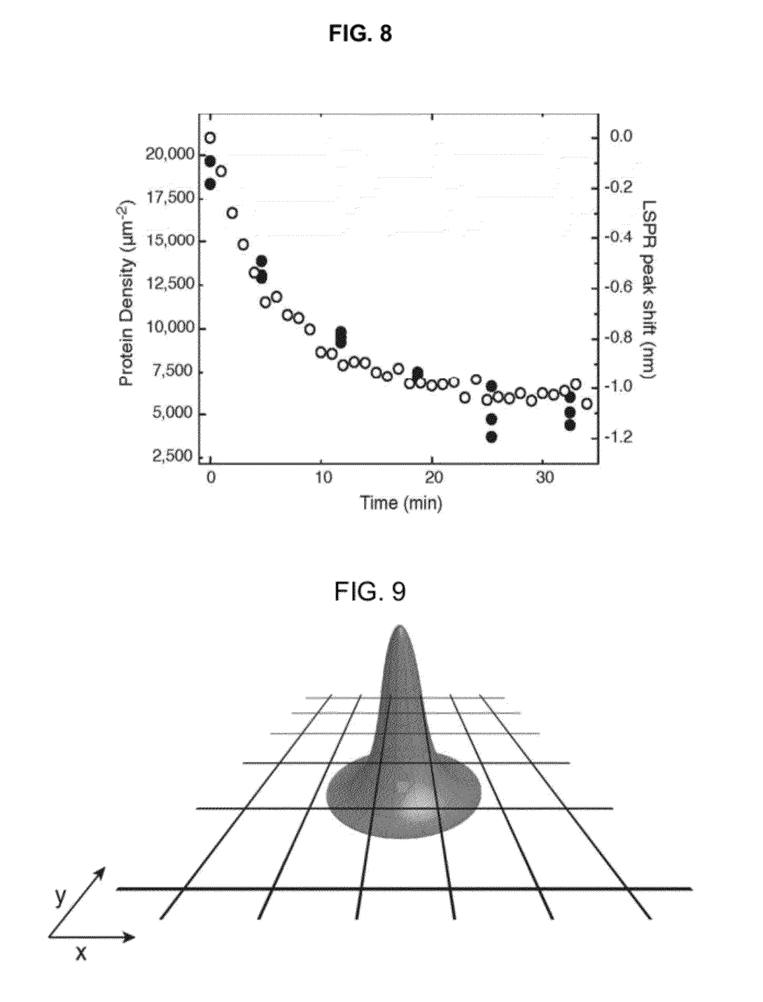

The fluorescence microscopy images used above also provide a direct way to estimate the amount of protein bound to the membrane, and thus the sensitivity of the LSPR assay. The absolute surface density of protein can be measured using a set of bilayer calibration standards containing varying concentrations of BODIPY-DHPE lipid (Invitrogen), which provide the relationship between fluorescence intensity and surface density of fluorophore. The intensity of YFP can be scaled to be directly comparable to that of BODIPY-DHPE, which allows the density of YFP to be inferred[Galush, W. J.; Nye, J. A.; Groves, J. T. Biophysical Journal 2008, 95, 2512-2519]. This analysis shows that initial protein density on the bilayer is approximately 21,000 μm⁻², and decreases over the course of the experiment to approximately 2,000 μm⁻² (FIG. 4). Since the membranes for fluorescence and LSPR measurements are the same, the fluorescence quantification may be used for the protein density scale in FIG. 3. This direct mapping is further supported by the similar desorption kinetics of two membranes (FIG. 8), and illustrates that the LSPR sensor can read out a wide range of bound protein densities. Thus, if properly calibrated, LSPR measurements provide a quantitative measurement of protein on the sensor surface. In this case, the change in protein density corresponds to a change in mass of 120 ng cm⁻² and a response factor of approximately 170 nm cm² ng⁻¹ for the LSPR measurements. Replicate sensor substrates made with the same batch of nanocubes have similar sensitivities.

### EXAMPLE 3

### Sensitivity of Nanocube-Plasmonic Sensor

An estimate of sensor noise is found by considering data from the negative control bilayer (without DOGS-NTA-Ni), shown in FIG. 3 (open squares), where protein binding to the membrane does not occur. The first sixty measurements have a standard deviation of 0.02 nm, which corresponds to a mass density of 1.5 ng cm⁻² by applying the sensitivity of 170 nm cm² ng⁻¹. This also results in a calculated limit of detection (3× noise)[Homola, J. Chemical Reviews 2008, 108, 462-493] of 4.5 ng cm⁻². The 0.02 nm value also provides an upper limit to the noise of the polynomial peak fitting method described above—the true resolution is likely much finer. While the limit of detection of supported bilayers formed in microfabricated nanoscale holes in metal films on glass is reported to be 0.1 ng cm⁻² [Dahlin, A. B.; Tegenfeldt, J. O.; Hook, F. Analytical Chemistry 2006, 78, 4416-4423], the numbers quoted for the nanocube membrane sensor here represent an un-optimized initial observation that is likely to be surpassed by further sensor development. Fundamentally the underlying optical physics is the same, so similar sensitivities are likely achievable in all formats.

### EXAMPLE 4

### Multi-Plex Applications for a Nanocube-Plasmonic Sensor

Many implementations of nanostructure-based sensors require complicated nanostructured templates and device fabrication. Realization of this sensor only requires simple-to-manufacture, self-assembled nanocube/bilayer detection surfaces, along with a standard absorbance spectrophotometer. The membrane-coated nanocube substrates are also potentially very easy to multiplex. Rather than a dedicated flow chamber as used here, it should be possible to realize the same basic system using glass-bottomed 96 well plates and an optical plate reader (e.g. high resolution models from Molecular Devices, BMGLabtech, and Biotek, among others). This allows easy multiplexing and scalability of the technique, since nanocube deposition, modification, and membrane coating could all be performed in an individual well whose spectrum is read out independently and analyzed as above. The membrane functionality of this technique allows readout of binding in an environment very different than that in solution or provided in most standard SPR formats. Some applications may not require the membrane environment itself, but membrane resistance to nonspecific binding (especially of proteins) may still prove useful as a scaffold for monitoring natively soluble proteins interacting with each other.

### REFERENCES

(1) Willets, K. A.; Van Duyne, R. P. Annual Review of Physical Chemistry 2007, 58, 267-297.
(2) Kelly, K.; Coronado, E.; Zhao, L.; Schatz, G. Journal of Physical Chemistry B 2003, 107, 668-677.
(3) Baciu, C. L.; Becker, J.; Janshoff, A.; Sonnichsen, C. Nano Letters 2008, 8, 1724-1728.
(4) Yonzon, C. R.; Jeoungf, E.; Zou, S. L.; Schatz, G. C.; Mrksich, M.; Van Duyne, R. P. Journal of the American Chemical Society 2004, 126, 12669-12676.
(5) Prikulis, J.; Hanarp, P.; Olofsson, L.; Sutherland, D.; Kall, M. Nano Letters 2004, 4, 1003-1007
6) Tao, A.; Sinsermsuksakul, P.; Yang, P. D. Angewandte Chemie-International Edition 2006, 45, 4597-4601.
(7) Tao, A.; Sinsermsuksakul, P.; Yang, P. Nature Nanotechnology 2007, 2, 435-440.
(8) Haes, A.; Chang, L.; Klein, W.; VanDuyne, R. Journal of the American Chemical Society 2005, 127, 2264-2271.
(9) Zhao, J.; Das, A.; Zhang, X.; Schatz, G.; Sligar, S.; VanDuyne, R. Journal of the American Chemical Society 2006, 128, 11004-11005.
(10) Haes, A. J.; Zou, S. L.; Schatz, G. C.; Van Duyne, R. P. Journal of Physical Chemistry B 2004, 108, 6961-6968.
(11) Hicks, E. M.; Zhang, X.; Zou, S.; Lyandres, O.; Spears, K. G.; Schatz, G. C.; Van Duyne, R. P. The Journal of Physical Chemistry B 2005, 109, 22351-22358.
(12) Rindzevicius, T.; Alaverdyan, Y.; Dahlin, A.; Hook, F.; Sutherland, D. S.; Kall, M. Nano Letters 2005, 5, 2335-2339.
(13) Handbook of surface plasmon resonance; Schasfoort, R. B., Tudos, A. J., Eds.; Royal Society of Chemistry: Cambridge, 2008.
(14) Drews, J. Science 2000, 287, 1960-1964.
(15) Yildirim, M. A.; Goh, K.-I.; Cusick, M. E.; Barabasi, A.-L.; Vidal, M. Nat Biotech 2007, 25, 1119-1126.
(16) Sackmann, E. Science 1996, 271, 43-48.
(17) Groves, J. T. Current Opinion in Drug Discovery and Development 2002, 5, 606-612.
(18) Tanaka, M.; Sackmann, E. Nature 2005, 437, 656-663.
(19) Bieri, C.; Ernst, O. P.; Heyse, S.; Hofmann, K. P.; Vogel, H. Nat Biotech 1999, 17, 1105-1108.
(20) Fang, Y.; Frutos, A. G.; Lahiri, J. ChemBioChem 2002, 3, 987-991.
(21) Gureasko, J.; Galush, W. J.; Boykevisch, S.; Sondermann, H.; Bar-Sagi, D.; Groves, J. T.; Kuriyan, J. Nat Struct Mol Biol 2008, 15, 452-461.
(22) Groves, J. T.; Dustin, M. L. Journal of Immunological Methods 2003, 278, 19-32.
(23) Mossman, K. D.; Campi, G.; Groves, J. T.; Dustin, M. L. Science 2005, 310, 1191-1193.
(24) Sherry, L. J.; Chang, S. H.; Schatz, G. C.; Van Duyne, R. P.; Wiley, B. J.; Xia, Y. N. Nano Letters 2005, 5, 2034-2038.
(25) Jung, L.; Campbell, C.; Chinowsky, T.; Mar, M.; Yee, S. Langmuir 1998, 14, 5636-5648.
(26) Zhou, Y.; Xu, H.; Dahlin, A. B.; Vallkil, J.; Borrebaeck, C. A. K.; Wingren, C.; Liedberg, B.; Hook, F. Biointerphases 2007, 2, 6-15.
(27) Leonenko, Z. V.; Finot, E.; Ma, H.; Dahms, T. E. S.; Cramb, D. T. Biophysical Journal 2004, 86, 3783-3793.
(28) Fievet, F.; Lagier, J. P.; Blin, B.; Beaudoin, B.; Figlarz, M. Solid State Ionics 1989, 32-33, 198-205.
(29) Sun, Y.; Xia, Y. Science 2002, 298, 2176-2179.
(30) Anker, J. N.; Hall, W. P.; Lyandres, O.; Shah, N. C.; Zhao, J.; Van Duyne, R. P. Nature Materials 2008, 7, 442-453.
(30) Anker, J. N.; Hall, W. P.; Lyandres, O.; Shah, N. C.; Zhao, J.; Van Duyne, R. P. Nature Materials 2008, 7, 442-453.
(32) Meuse, C. W.; Niaura, G.; Lewis, M. L.; Plant, A. L. Langmuir 1998, 14, 1604-1611.
(33) Kastl, K.; Ross, M.; Gerke, V.; Steinem, C. Biochemistry 2002, 41, 10087-10094.
(34) Jackson, B. L.; Nye, J. A.; Groves, J. T. Langmuir 2008, 24, 6189-6193.
(35) Groves, J. T.; Ulman, N.; Boxer, S. G. Science 1997, 275, 651-653.
(36) Groves, J. T.; Ulman, N.; Cremer, P. S.; Boxer, S. G. Langmuir 1998, 14, 3347-3350
(37) Haes, A.; Zou, S.; Zhao, J.; Schatz, G.; VanDuyne, R. Journal of the American Chemical Society 2006, 128, 10905-10914.
(38) Zhang, J.; Fu, Y.; Chowdhury, M. H.; Lakowicz, J. R. Journal of Physical Chemistry C 2008, 112, 9172-9180.
(39) Sanii, B.; Parikh, A. N. Soft Matter 2007, 3, 974-977.
(40) Nenninger, G. G.; Piliarik, M.; Homola, J. Measurement Science and Technology 2002, 13, 2038-2046.
(41) Dahlin, A. B.; Tegenfeldt, J. O.; Hook, F. Analytical Chemistry 2006, 78, 4416-4423.
(42) Ormö, M.; Cubitt, A. B.; Kallio, K.; Gross, L. A.; Tsien, R. Y.; Remington, S. J. Science 1996, 273, 1392-1395.
(43) Salafsky, J.; Groves, J. T.; Boxer, S. G. Biochemistry 1996, 35, 14773-14781.
(44) Yoshina-Ishii, C.; Boxer, S. G. Journal of the American Chemical Society 2003, 125, 3696-3697.
(45) Parthasarathy, R.; Groves, J. T. Proceedings of the National Academy of Sciences of the United States of America 2004, 101, 12798-12803.
(46) Nye, J. A.; Groves, J. T. Langmuir 2008, 24, 4145-4149.
(47) Galush, W. J.; Nye, J. A.; Groves, J. T. Biophysical Journal 2008, 95, 2512-2519.
(48) Homola, J. Chemical Reviews 2008, 108, 462-493.

The above examples are provided to illustrate the invention but not to limit its scope. Other variants of the invention will be readily apparent to one of ordinary skill in the art and are encompassed by the appended claims. All publications, databases, and patents cited herein are hereby incorporated by reference for all purposes.

We claim:

1. A composition comprising,
a substrate having a continuous membrane coating, wherein the substrate features nanoparticles disposed between the membrane coating and the substrate.

2. The composition of claim 1, wherein the substrate is substantially planar.

3. The composition of claim 1, wherein the substrate is spherical.

4. The composition of claim 1, wherein the substrate is a wall of a microfluidic channel.

5. The composition of claim 1, wherein the membrane coating over the substrate is a supported lipid bilayer and the membrane coating over the nanoparticles is a hybrid lipid bilayer.

6. The composition of claim 1, wherein the nanoparticles comprising nanopolyhedras.

7. The composition of claim 6, wherein a nanopolyhedra is a nanocube.

8. The composition of claim 1, wherein the nanoparticles comprising a metal, a semiconductor material, multi-layers of metals, a metal oxide, an alloy, a polymer, or carbon nanomaterials.

9. The composition of claim 1, wherein the nanoparticles are chemically modified to display a self-assembled monolayer.

10. The composition of claim 1, wherein the membrane coating further comprising a ligand within the membrane.

11. The composition of claim 1, further comprising an analyte molecule possibly capable of binding the ligand.

12. The composition of claim 11, wherein the analyte is a cell-surface protein or a functionalized lipid headgroup.

13. A method comprising:
contacting a target molecule with a substrate having a continuous membrane coating a plurality of nanoparticles disposed between the membrane and the substrate, applying a molecule possibly capable of binding the target molecule, and detecting plasmon generated phenomena at a nanoparticle.

14. The method of claim 13, wherein the plasmon-generated phenomena is optically detectable.

15. The method of claim 13, wherein detecting plasmon-generated phenomena comprises detecting light selected from absorbed light, reflected light, scattered light, or any combination thereof, and further wherein the method of detection comprises any combination selected from imaging, spectral characterization, intensity measurement, interferometry, and interference fringe analysis.

16. The method of claim 13, wherein the nanoparticle is a nanopolyhedra.

17. The method of claim 16, wherein the nanopolyhedra is a nanocube.

18. The method of claim 13, further comprising,
detecting a spectral shift in the known spectra of the nanoparticles, wherein such a spectral shift indicates the presence of the molecule possibly capable of binding the target molecule.

19. The method of claim 13, wherein the target molecule is a cell-membrane protein or a functionalized lipid headgroup.

20. A sensor comprising a substrate having nanoparticles embedded on said substrate and a continuous supported lipid membrane coating said substrate and nanoparticles, wherein the nanoparticles are chemically modified to display a self-assembled monolayer such that subsequent exposure of the surface to lipid vesicles results in formation of a continuous lipid membrane coating the nanoparticles and the supporting substrate.

21. A method for detecting an analyte of interest comprising the steps of:
(a) providing a substrate having a continuous membrane coating, wherein the substrate features nanoparticles disposed between the membrane coating and the substrate, wherein the nanoparticles have a known spectra, and wherein the continuous membrane displays a ligand for the analyte of interest;
(b) applying a sample suspected of containing a target analyte of interest to the substrate;
(c) detecting plasmon generated phenomena at the nanoparticles, whereby a spectral shift in the known spectra of the nanoparticles indicates that the target analyte is bound to the ligand.

22. The method of claim 21, wherein the substrate is substantially planar.

23. The method of claim 21, wherein the substrate is spherical.

24. The method of claim 21, wherein the substrate is a wall of a microfluidic channel.

25. The method of claim 21, wherein the membrane coating over the substrate is a supported lipid bilayer and the membrane coating over the nanoparticles is a hybrid lipid bilayer.

26. The method of claim 21, wherein the nanoparticles comprising nanopolyhedras.

27. The method of claim 26, wherein the nanopolyhedra is a nanocube.

28. The method of claim 21, wherein the nanoparticles comprising a metal, a semiconductor material, multi-layers of metals, a metal oxide, an alloy, a polymer, or carbon nanomaterials.

29. The method of claim 28, wherein the nanoparticles comprising silver or gold.

30. The method of claim 21, wherein the nanoparticles are chemically modified to display a self-assembled monolayer.

31. The method of claim 30, wherein the self-assembled monolayer comprising alkanethiols, chlorosilanes, disulfides, amines, alcohols, carboxylic acids or phosphonic acids.

32. The method of claim 21, wherein the ligand within the membrane is selected from the group consisting of: oligonucleotides, ribonucleic acid residues, deoxyribonucleic acid residues, polypeptides, proteins, receptors, carbohydrates, a lipid-linked small molecule, thyroxine binding globulin, antibodies, enzymes, Fab fragments, lectins, nucleic acids, nucleic acid aptamers, avidin, protein A, barsar, complement component C1q, and other organic or inorganic molecules having a binding affinity for an analyte of interest.

33. The method of claim 21, wherein the analyte of interest is selected from the group consisting of: nucleic acid molecules, proteins, peptides, haptens, metal ions, drugs, metabolites, pesticides, pollutants, toxins, hormones, enzymes, lectins, proteins, signaling molecules, inorganic or organic molecules, antibodies, contaminants, viruses, bacteria, other pathogenic organisms, idiotopes and cell surface markers.

34. The method of claim 21, wherein detecting plasmon-generated phenomena comprises detecting light selected from absorbed light, reflected light, scattered light, or any combination thereof, and further wherein the method of detection comprises any combination selected from imaging, spectral characterization, intensity measurement, interferometry, and interference fringe analysis.
